(19) United States
(12) Patent Application Publication
(10) Pub. No.: US 2019/0021301 A1
(43) Pub. Date: Jan. 24, 2019

(54) FISHING HOOK SNARE SYSTEM

(71) Applicant: Ryan Hagerman, St. Cloud, FL (US)

(72) Inventor: Ryan Hagerman, St. Cloud, FL (US)

(21) Appl. No.: 15/657,701

(22) Filed: Jul. 24, 2017

(51) Int. Cl. A01K 99/00

(52) U.S. Cl. CPC A01K 99/00; A01K 61/10

(57) ABSTRACT

A fishing hook snare system includes an elongated main body member that is constructed from a material suitable for prolonged exposure to an underwater environment. A plurality of snares are disposed along the main body. Each of the snares including a shape, size and construction material for engaging fishing hooks and entangling the same. A positioning unit having a plurality of weighted elements is in communication with the main body. The positioning unit having a tether and anchors for selectively positioning the main body a discrete distance from the bottom surface of the body of water or on the surface of the body of water.

### TECHNICAL FIELD

The present invention relates generally to fishing, and more particularly to a fishing hook snare system to prevent unauthorized fishing of lakes and other bodies of water.

### BACKGROUND

The statements in this section merely provide background information related to the present disclosure and may not constitute prior art.

There are many state and federal regulations pertaining to wildlife preservation, such as catch limits and geographic areas where fishing is not authorized. For example, government property such as retention ponds and/or streams where fish are known to spawn are often posted with “No Fishing” signs that are enforced by local authorities.

Additionally, owners of waterfront property often struggle with keeping fisherman from trespassing on their private lands and fishing from shore. This is especially the case with unimproved land owners, who are not able to continuously monitor their physical property.

Accordingly, it would be beneficial to provide a fishing hook snare system that can be permanently or removably positioned along prohibited areas to prevent illegal or unauthorized fishing, so as to alleviate the problems described above.

### SUMMARY OF THE INVENTION

The present invention is directed to a fishing hook snare system. One embodiment of the present invention can include an elongated main body member that is constructed from a material suitable for prolonged exposure to an underwater environment. A plurality of snares can be disposed along the main body and can include a shape, size and construction material that are suitable for engaging fishing hooks and entangling the same.

In one embodiment, a positioning unit can be secured along the main body and can function to maintain the same along the bottom surface of a body of water. In one embodiment, the positioning unit can include a tether for selectively positioning the main body a discrete distance above the bottom surface of the body of water or on the surface of the body of water.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a fishing hook snare system that is useful for understanding the inventive concepts disclosed herein.

FIG. 2A is a bottom end view of the fishing hook snare system, in accordance with one embodiment of the invention.

FIG. 2B is a perspective view of the fishing hook snare system in operation, in accordance with one embodiment of the invention.

FIG. 3 is another perspective view of the fishing hook snare system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

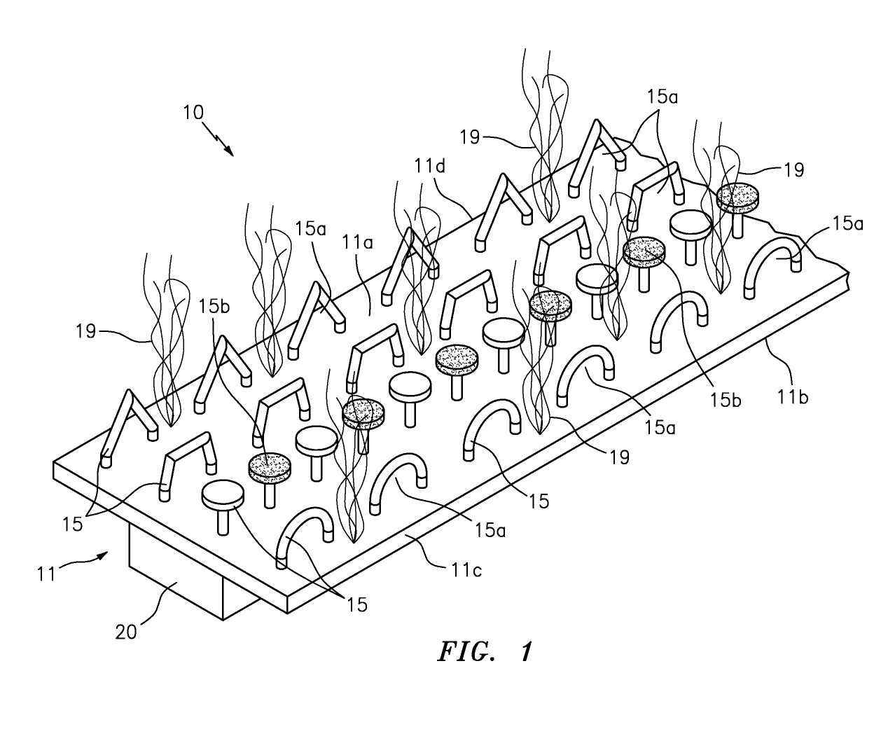

FIGS. 1-3 illustrate one embodiment of a fishing hook snare system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in FIG. 1, the system 10 can include, essentially, a main body section 11 having a plurality of snares 15 that are embedded along the top surface, and a positioning unit 20 along the bottom surface thereof.

In one embodiment, the main body can include an elongated member having a top surface 11a, a bottom surface 11b, and a pair of side surfaces 11c and 11d. In the preferred embodiment, the main body can be constructed as a continuous strip of resilient material such as a composition of sand and rubber filaments, for example, that can be rolled into place. In the preferred embodiment, the main body can be constructed so as to be slightly buoyant, (e.g., impart approximately 11b of upward force when submerged at 10′); however, other buoyancy forces are contemplated.

Of course, the main body is not limited to such a shape and material, as other embodiments are contemplated wherein the main body is constructed from any type of materials that are, for example, relatively strong and stiff for their weight, and suitable for prolonged exposure to an underwater environment. Several nonlimiting examples include, but are not limited to various types of plastic/polymers (e.g., high-density polyethylene (HDPE) or polyethylene terephthalate (PET)), and/or composite materials (e.g., carbon fibers in a polymer matrix, fiberglass, etc.). Moreover, the main body can include any number of different colors and/or markings so as to seamlessly blend with the natural environment to which it will be deployed.

As shown, a plurality of snares 15 can be disposed along at least one surface of the main body, so as to extend outward therefrom. Each of the snares can include any number of different shapes and sizes, and can include at least one end, but preferably two ends, that are permanently embedded within the main body 11, so as to form a semi-circular and/or loop section 15a that is designed to engage the curved end of a fishing hook and/or fishing line.

Each of the snares 15 may be constructed from any number of different materials that are suitable for prolonged exposure to an underwater environment. For example, in one embodiment, the snares may be constructed from thin pieces of steel, for example, that are coated with plastic to prevent rust. Likewise, one or more of the snares 15b may include or be constructed from a magnetized material so as to attract the hook/weights of a fishing rig. Of course, other embodiments are also contemplated, as the snares 15 may also be constructed from a substantially identical material as the main body, so as to be formed as a unitary element therewith. In either instance, it is preferred that the snares and main body combination be constructed so as to resist the pulling force of a 501b test fishing line, which is typically the largest type of line utilized for shoreline fishing.

In one embodiment, a plurality of resilient filaments 19 can be positioned along the top surface of the main body, so as to provide the appearance of natural weeds, for example. Such a feature can help to provide a more “natural” appearance to the system, and may act as a breeding ground for fish. The filaments preferably being constructed from an identical material as the main body, but may be constructed from other materials as well.

The positioning unit 20 can function to anchor the system at any desirable location along, above or within any body of water such as a lake, river, ocean or retention pond, for example, so as to counteract fishing attempts on the bottom or top/middle portions of the water, respectively.

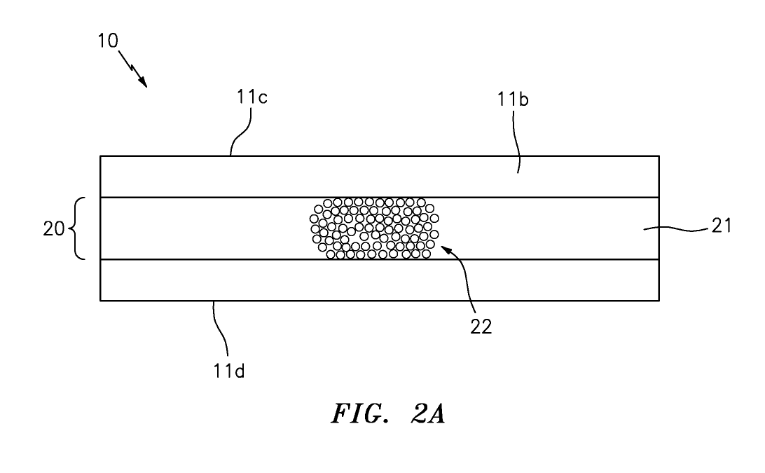

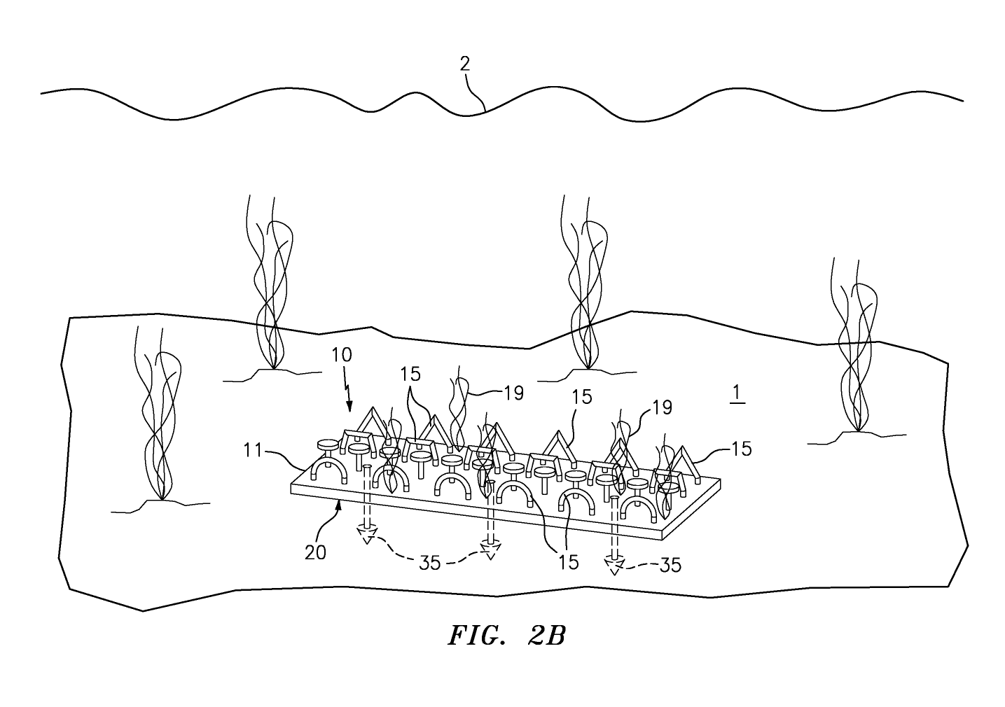

FIGS. 2A and 2B illustrate one embodiment of the positioning unit 20 for securing the system directly onto the floor of a body of water. As shown, the unit can include an elongated channel 21 that is secured along, or within the main body 11. In the preferred embodiment, the channel 21 can house a plurality of individual weighted elements 22, such as balls of plastic-coated lead shot, for example. Such components are commonly utilized for soft weights in recreational diving applications and are proven to be environmentally friendly.

In this regard, the resilient nature of the weighted elements 22 and channel 21 allows the system to be easily deployed as described above, and will function to secure the main body directly onto the surface of the body of water 1.

Of course, other embodiments are contemplated, wherein the weighted elements are constructed from different materials that are positioned within the channel or directly along the main body. Additionally, any number of anchoring elements 35 such as stakes, posts or other such devices may be used to prevent movement of the system.

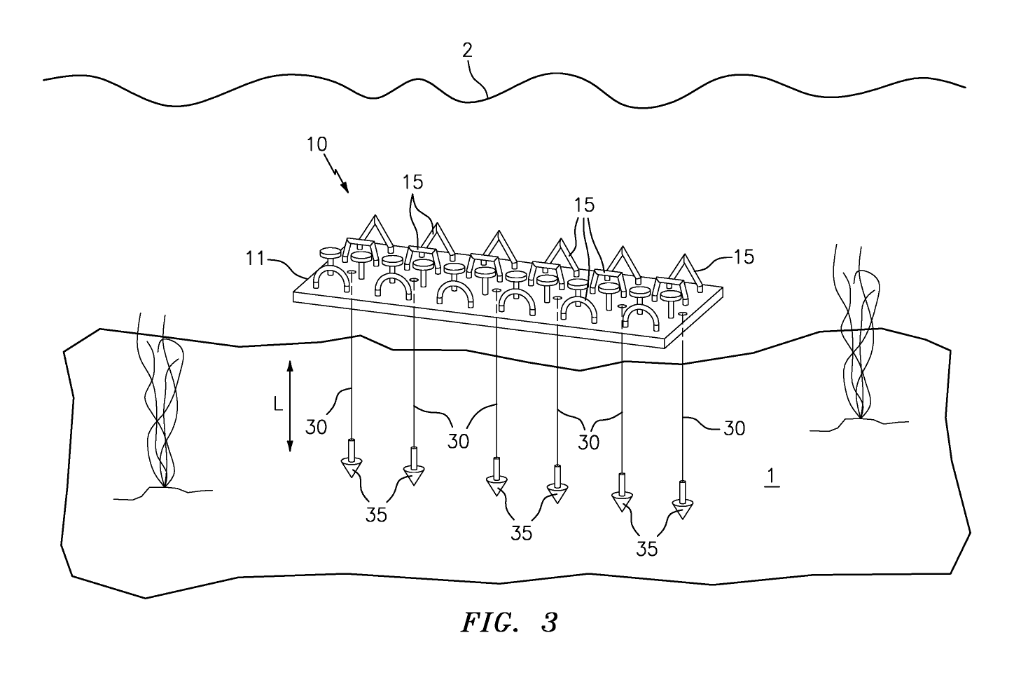

FIG. 3 illustrates one embodiment of the positioning unit 20 for suspending the system above the floor of the body of water 1. As shown, a plurality of tethers 30 can be secured onto the main body 11 at a first end, and can include anchors 35 along the second end. As described herein, each of the anchors 35 can include any number of weighted elements, stakes, posts or other such devices that can be positioned along or within the body of water to prevent movement of the system.

As shown, such a feature advantageously allows the slightly buoyant nature of the main body 11 to be positioned along the water surface 2 and/or at any desirable depth below the water surface by simply adjusting the length L of each tether 30.

In operation, the system 10 can be deployed adjacent to the shoreline of any body of water to which it is desirable to prevent fishing. Depending on the amount of shoreline to be protected and the length (e.g., major axis) of the system produced, users can deploy any number of individual systems longitudinally, so as to protect an unlimited distance.

Once deployed along or within the body of water of the same, the snares can function to snag the hook or bait of any fishing line it encounters. When so entrapped, the fisherman will have no choice but to cut their line and lose their bait. Such a feature therefore acts as a strong deterrent against continued illegal or unauthorized fishing activities.

Although dimensions are not critical, in the preferred embodiment, the main body can be produced in lengths (e.g., distance along the major axis) of between 20 and 50 feet; the main body can be produced in widths (e.g., distance between sides 11c and 11d) of between 2 and 8 inches; and the snares can include a height (e.g., separation distance from the main body surface) of approximately 1-3 inches. Such dimensions being particularly suitable for use in freshwater environments so as to be deployed without the aid of specialized equipment or knowledge. Of course, other dimensions are contemplated.

As described herein, one or more elements of the fishing hook snare system 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the main body 11, snares 15, filaments 19 and/or positioning unit 20, for example, may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A fishing hook snare system, comprising:
an elongated main body member having an upper surface and a lower surface;
a plurality of snares that are disposed along the upper surface of the elongated main body; and
a positioning unit that is in communication with the main body and is configured to engage a floor of a body of water.

2. The system of claim 1, wherein the main body is constructed from an elongated piece of resilient material that is suitable for prolonged exposure to an underwater environment.

3. The system of claim 1, wherein the main body is constructed from an elongated piece of rigid material that is suitable for prolonged exposure to an underwater environment.

4. The system of claim 1, wherein a portion of each of the snares forms a semi-circular element that is configured to engage a fishing hook.

5. The system of claim 1, wherein at least one of the snares are magnetic.

6. The system of claim 1, wherein the main body is buoyant.

7. The system of claim 1, wherein the positioning unit includes at least one weighted element.

8. The system of claim 1, wherein the positioning unit includes at least one anchoring element.

9. The system of claim 1, wherein the positioning unit includes functionality for positioning the main body directly onto the floor of the body of water.

10. The system of claim 1, wherein the positioning unit includes functionality for positioning the main body a set distance above the floor of the body of water.

11. The system of claim 10, wherein the set distance is adjustable.
